(19) United States
(12) Patent Application Publication
(10) Pub. No.: US 2010/0275593 A1
(43) Pub. Date: Nov. 4, 2010

(54) BRAKE SYSTEM

(76) Inventors: Satoru Okada, Minami Alps-shi (JP); Yukihiko Yamada, Minami Alps-shi (JP)

Correspondence Address: WENDEROTH, LIND & PONACK, L.L.P., 1030 15th Street, N.W.,, Suite 400 East, Washington, DC, 20005-1503, US

(21) Appl. No.: 12/730,692

(22) Filed: Mar. 24, 2010

(30) Foreign Application Priority Data
Apr. 30, 2009 (JP) 111083/2009

(51) Int. Cl. B60T 11/16

(52) U.S. Cl. 60/545

(57) ABSTRACT

There is provided a brake system that can generate a desired braking force in a nondefective system even if at least a secondary side system of a tandem master cylinder is defective. When the secondary side system is defective, a primary piston (assist member) is moved by a larger amount than an amount of movement of an input piston (input member). Pressure in the nondefective primary side system is increased, and this can compensate for a braking force for two wheels on the primary side, which may be reduced by the defect in the secondary side if no measure is taken, and allows a desired braking force to be generated. Further, the pressure in the primary side system is increased to apply hydraulic pressure reaction to the input piston and an input rod (input member), thereby achieving good pedal feeling.

### BACKGROUND OF THE INVENTION

The present invention relates to a brake system that assists in a brake input with an electric actuator.

Conventionally, a brake system has been known using an electric boosting device that is mounted to a tandem master cylinder and assists in a brake input with an electric actuator, and that allows relative displacement between an input member and an assist member (for example, see Japanese Patent Laid-Open No. 2007-191133).

The brake system using the electric boosting device as described above controls the assist member to operate at a certain ratio in response to an operation of the input member in normal braking. If the control in the normal braking is performed when one of the systems of the tandem master cylinder is defective, a braking force becomes insufficient even in a nondefective system.

### SUMMARY OF THE INVENTION

The present invention has an object to provide a brake system that can generate a desired braking force in a nondefective system even if at least a secondary side system of a tandem master cylinder is defective.

The present invention provides a brake system comprising;

a master cylinder that includes two pistons slidably provided in a cylinder, and in which brake hydraulic pressure is generated in two chambers of primary and secondary pressure chambers and is supplied from the primary and secondary pressure chambers to a wheel cylinder via a primary side system and a secondary side system respectively;

an electric boosting device that includes an input member that is moved forward and backward by an operation of a brake pedal and to which hydraulic pressure in the primary pressure chamber is applied, and an assist member that is moved forward and backward by an electric actuator, the electric boosting device generating brake hydraulic pressure in the master cylinder from an input thrust applied from the brake pedal to the input member and an assist thrust applied from the electric actuator to the assist member; and

a control device that drives the electric actuator in response to an operation of the input member.

When the secondary side system of the primary and secondary side systems is defective, the control device drives the electric actuator so that an amount of movement of the assist member relative to an amount of movement of the input member is larger than that when both the systems are in normal states.

### BRIEF DESCRIPTION OF THE DRAWINGS

FIG. 1A shows an entire configuration of a brake system according to a first embodiment of the present invention;

FIG. 1B shows a sectional view of a master cylinder and an electric boosting device in FIG. 1A;

FIG. 2 shows a flowchart illustrating a control process of a controller in FIG. 1A;

FIGS. 3A1, 3A2 and 3A3 illustrate a control process in FIG. 2,

FIG. 3A1 shows a sectional view of the master cylinder when a secondary-piston-side system is defective,

FIG. 3A2 shows a sectional view of the master cylinder when a primary piston side system is defective, and

FIG. 3A3 shows the characteristics of the primary master cylinder pressure with regard to the primary piston displacement in normal time and in the case of a defect;

FIGS. 3B1, 3B2, 3B3 and 3B4 illustrate a defect position identification process by a controller in FIG. 1A,

FIG. 3B1 shows a sectional view of the master cylinder corresponding to a defect position identification process when the secondary piston side system defective,

FIG. 3B2 shows a sectional view of the master cylinder corresponding to a defect position identification process when the primary piston side system is defective,

FIG. 3B3 shows defect position detection based on the pressure characteristics, and shows the characteristics of the pressure of the primary-side master cylinder with regard to the primary piston displacement, in normal time, in the case of a defect at the secondary side, and in the case of defects at the primary or all systems, and

FIG. 3B4 shows defect position detection based on the motor current characteristics, and shows the characteristics of the motor current with regard to the primary piston displacement, in normal time and in the case of defects at all systems, and the characteristics of the motor current with regard to the primary piston displacement in the case of a defect at the primary or secondary side;

FIGS. 3C1, 3C2, 3C3 and 3C4 illustrate the control process in FIGS. 3A1-3A3 and 3B1-3B4,

FIG. 3C1 shows a sectional view of the master cylinder corresponding to a process after a defect position is identified in the secondary piston side system,

FIG. 3C2 shows a sectional view of the master cylinder corresponding to a process after a defect position is identified in the primary piston side system,

FIG. 3C3 shows the characteristics of the input piston displacement and the primary piston displacement (input/output characteristics) in the case of a defect at one of the systems, and

FIG. 3C4 shows the characteristics of the pressure of the primary side master cylinder with regard to the input piston displacement including an invalid stroke in the case of a defect;

FIG. 4A shows a flowchart illustrating a control process of a controller (second embodiment controller) used in a brake system according to a second embodiment of the present invention;

FIG. 4B shows a flowchart illustrating a control process performed following a Yes determination process in Step S410 in FIG. 4A;

FIGS. 5-1, 5-2, 5-3 and 5-4 illustrate the control processes in FIGS. 4A and 4B,

FIG. 5-1 shows a sectional view of a master cylinder when a secondary piston side system is defective,

FIG. 5-2 shows a sectional view of a master cylinder when a primary piston side system is defective,

FIG. 5-3 shows defect position detection based on the pressure characteristics, and shows the characteristics of the pressure of the primary master cylinder with regard to the primary piston displacement, in normal time and in the case of a defect, and

FIG. 5-4 shows the characteristics of the input piston displacement and the primary piston displacement (input/output characteristics) in the case of a defect at one of the systems;

FIG. 6A shows a flowchart illustrating a control process of a controller (third embodiment controller) used in a brake system according to a third embodiment of the present invention;

FIG. 6B shows a flowchart illustrating a control process performed following a Yes determination process in Step S610 in FIG. 6A; and

FIG. 7 shows the characteristics of the input piston displacement and the primary piston displacement (input/output characteristics) in the case of a defect at one of the systems, for illustrating control process in FIG. 6B.

### DETAILED DESCRIPTION OF THE INVENTION

### First Embodiment

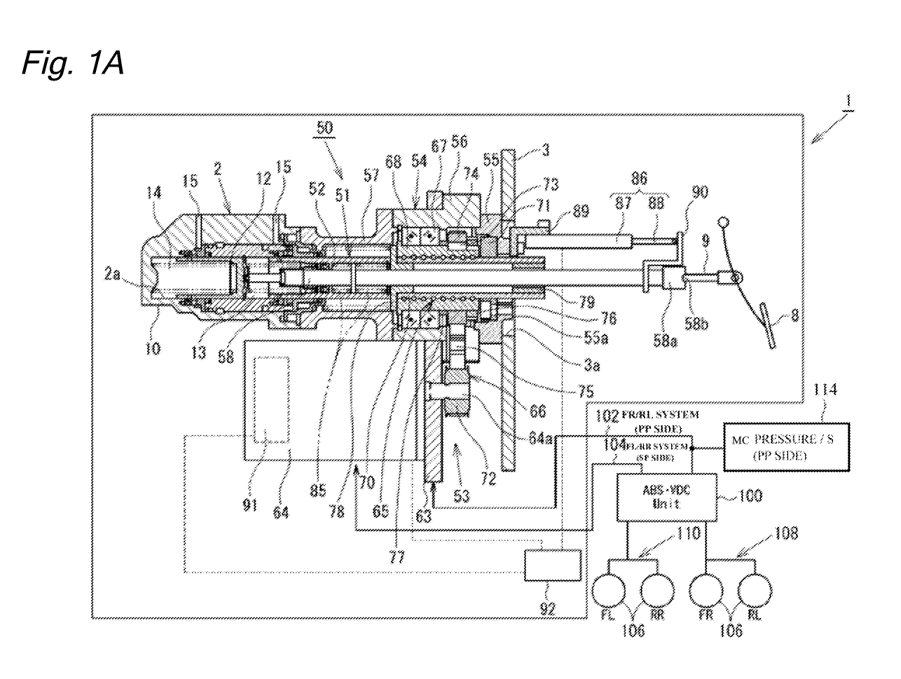

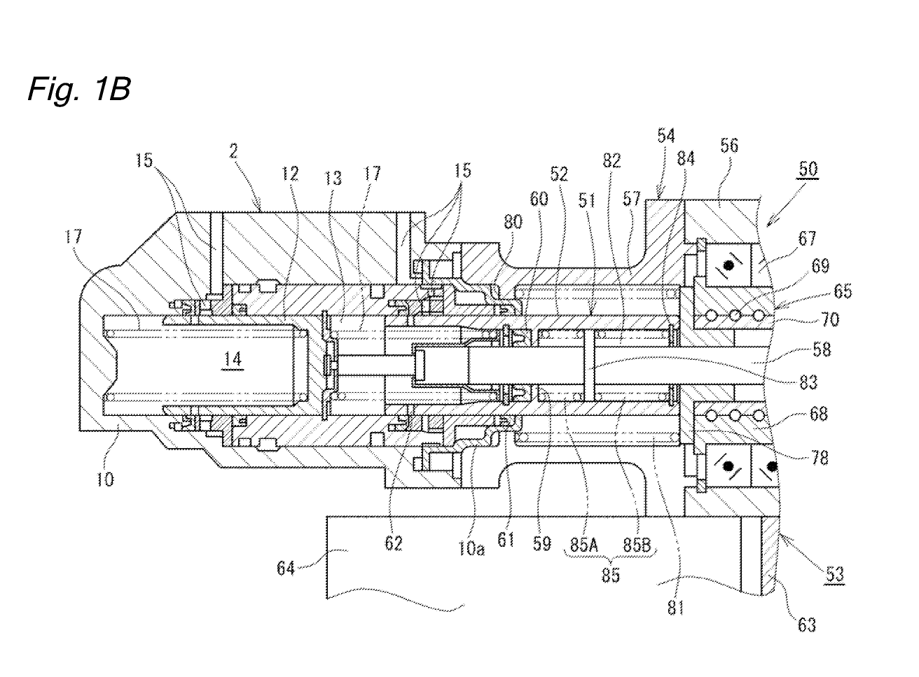

Now, a brake system according to a first embodiment of the present invention will be described with reference to FIGS. 1A, 1B, 2, 3A1-3A3, 3B1-3B4, and 3C1-3C4.

In FIGS. 1A and 1B, the brake system 1 according to this embodiment includes a tandem master cylinder 2 (hereinafter simply referred to as a master cylinder), an electric boosting device 50, and a controller 92 as an example of a control device.

The master cylinder 2 includes two pistons (referred to as a primary piston 52 and a secondary piston 12 as appropriate) provided slidably in a cylinder bore 2a (hereinafter may be referred to as cylinder). The cylinder bore 2a, the primary piston 52 and the secondary piston 12 form two pressure chambers of a primary-side pressure chamber and a secondary-side pressure chamber (hereinafter referred to as a primary-piston-side pressure chamber 13 and a secondary-piston-side pressure chamber 14). Brake hydraulic pressure generated in the primary-piston-side pressure chamber 13 and the secondary-piston-side pressure chamber 14 is supplied to wheel cylinders 106 via hydraulic pressure circuits each having one end connected to the primary-piston-side pressure chamber 13 and the secondary-piston-side pressure chamber 14, respectively, and the other end connected to a hydraulic pressure control unit 100 (hereinafter referred to as a primary side circuit 102 and a secondary side circuit 104). The primary-piston-side and secondary-piston-side pressure chambers 13 and 14 are also simply referred to as pressure chambers 13 and 14.

In this embodiment, the primary-piston-side pressure chamber 13 and the primary circuit 102 constitute a primary side system, and the secondary-piston-side pressure chamber 14 and the secondary circuit 104 constitute a secondary side system.

The hydraulic pressure control unit 100 and each wheel cylinder 106 of four wheels (FR, RL, FL and RR) are connected by pipes (a primary pipe 108 and a secondary pipe 110). The primary pipe 108 extends from the hydraulic pressure control unit 100 correspondingly to the primary circuit 102 and branches off at its front end, and is connected to wheel cylinders 106 corresponding to the front right wheel (FR) and the rear left wheel (RL). The secondary pipe 110 extends from the hydraulic pressure control unit 100 correspondingly to the secondary circuit 104 and branches off at its front end, and is connected to wheel cylinders 106 corresponding to the front left wheel (FL) and the rear right wheel (RR). The pipes 108 and 110 constitute a so-called X pipe.

The electric boosting device 50 includes a piston assembly 51 described later shared as a primary piston of the master cylinder 2, and an electric actuator 53 including an electric motor 64 described later that applies a thrust to a booster piston (primary piston) 52 that constitutes the piston assembly 51. The piston assembly 51, the booster piston 52, and the electric actuator 53 are provided inside and outside a housing 54 secured to a vehicle chamber wall 3.

The booster piston 52 is hereinafter also referred to as a primary piston 52.

The electric boosting device 50 further includes an input rod 9 and an input piston 58 (input member) that are moved forward and backward by an operation of a brake pedal 8 and to which hydraulic pressure in the primary-piston-side pressure chamber 13 is applied.

The primary piston 52 that constitutes the piston assembly 51 is moved forward and backward by the thrust applied by the electric actuator 53 including the electric motor 64.

The electric boosting device 50 generates brake hydraulic pressure in the master cylinder 2 with an input thrust applied from the brake pedal 8 to the input rod 9 and an assist thrust applied from the electric motor 64 to the primary piston 52. In this embodiment, the primary piston 52 constitutes an assist member.

The controller 92 drives the electric motor 64 and thus the electric actuator 53 in response to the operation of the input rod 9.

The housing 54 includes a first cylindrical body 56 secured to a front surface of the vehicle chamber wall 3 via a ring-shaped mounting member 55, and a second cylindrical body 57 coaxially coupled to the first cylindrical body 56. The master cylinder 2 is coupled to a front end of the second cylindrical body 57. A support plate 63 is mounted to the first cylindrical body 56, and the electric motor 64 is secured to the support plate 63. The mounting member 55 is secured to the vehicle chamber wall 3 so that an inner diameter boss 55a of the mounting member 55 is placed in an opening 3a in the vehicle chamber wall 3.

The piston assembly 51 is formed so that the input piston 58 is inserted in the primary piston 52 movably relative to the primary piston 52. The input piston 58 is adapted to be moved forward and backward by an operation of the brake pedal 8 (pedal operation) by coupling the input rod 9 extended from the brake pedal 8 to a large diameter portion 58a provided at a rear end of the input piston 58. In this case, the input rod 9 is coupled to the input piston 58 with a front end of the input rod 9 fitted in a spherical recess 58b provided in the large diameter portion 58a, and this allows the input rod 9 to swing.

As clearly shown in FIG. 1B, the primary piston 52 includes a bulkhead (partition wall) 59 in a longitudinally intermediate portion, and the input piston 58 is extended through the bulkhead 59. A front end of the primary piston 52 is inserted into the cylinder bore 2a in the master cylinder 2 to face the inside of the pressure chamber 13. Meanwhile, a front end of the input piston 58 is placed inside the primary piston 52 so as to face the pressure chamber 13. A seal member 60 placed in front of the bulkhead 59 of the primary piston 52 seals between the primary piston 52 and the input piston 58. Also, a seal member 61 seals between the primary piston 52 and a guide 10a of a cylinder body 10 of the master cylinder 2. The seal members 60 and 61 prevent a brake fluid from leaking from the pressure chamber 13 to the outside of the master cylinder 2. In a front end of the primary piston 52, a plurality of through holes 62 are provided that can communicate with a relief port 15, which is formed in the master cylinder 2 and is connected to a reservoir (not shown).

The electric actuator 53 mainly includes the electric motor 64, the ball screw mechanism 65, and the rotation transmission mechanism 66. The electric motor 64 is secured to the support plate 63 integral with the first cylindrical body 56 of the housing 54. The ball screw mechanism 65 is provided in the first cylindrical body 56 to surround the input piston 58. The rotation transmission mechanism 66 is configured such that it decelerates rotation of the electric motor 64 and transmits the rotation to the ball screw mechanism 65. The ball screw mechanism 65 includes a nut member 68 rotatably supported by the first cylindrical body 56 via a bearing (angular contact bearing) 67, and a hollow screw shaft 70 engaging the nut member 68 via balls 69. A rear end of the screw shaft 70 is nonrotatably and slidably supported by a ring guide 71 secured to the mounting member 55 of the housing 54, and this causes the screw shaft 70 to linearly move with rotation of the nut member 68. Meanwhile, the rotation transmission mechanism 66 includes a first pulley 72 mounted to an output shaft 64a of the electric motor 64, a second pulley 74 nonrotatably fitted to the nut member 68 via a key 73, and a belt (timing belt) 75 wound around the two pulleys 72 and 74. The second pulley 74 has a larger diameter than the first pulley 72, and thus the rotation of the electric motor 64 is decelerated and transmitted to the nut member 68 of the ball screw mechanism 65. The angular contact bearing 67 is pressurized by a nut 76 threaded into the nut member 68 via the second pulley 74 and a collar 77. The rotation transmission mechanism 66 is not limited to the pulley or the belt described above, but may be a reduction gear mechanism or the like.

A flange member 78 is fitted and secured to a front end of the hollow screw shaft 70 that constitutes the ball screw mechanism 65. A cylindrical guide 79 is fitted and secured to a rear end of the screw shaft 70. Inner diameters of the flange member 78 and the cylindrical guide 79 are set so that the flange member 78 and the cylindrical guide 79 serve as guides for slidably guiding the input piston 58. The flange member 78 is brought into contact with the rear end of the primary piston 52 in response to forward (leftward in the drawing) movement of the screw shaft 70. The forward movement of the screw shaft 70 causes forward movement of the primary piston 52. In the second cylindrical body 57 that constitutes the housing 54, a return spring 81 is provided having one end locked to an annular protrusion 80 formed on an inner surface of the second cylindrical body 57 and the other end abutting against the flange member 78. The return spring 81 positions the screw shaft 70 in a shown original position in non-operating time of the brake.

An annular space 82 is defined between the input piston 58 and the primary piston 52. In the annular space 82, a pair of springs (urging means) 85 (85A and 85B) are provided having one end locked to a flange 83 provided on the input piston 58 and the other end locked to the bulkhead 59 of the primary piston 52 and a snap ring 84 fitted to the rear end of the primary piston 52, respectively. The pair of springs 85 serve to hold the input piston 58 and the primary piston 52 in a neutral position of relative movement in the non-operating time of the brake. The neutral position is defined as a position where the input piston 58 can be moved to axially opposite sides relative to the primary piston 52.

In the first embodiment, a potentiometer (absolute displacement detection means) 86 that detects absolute displacement of the input piston 58 relative to a vehicle body is provided in a cabin. The potentiometer 86 includes a main body 87 including a resistor, and a sensor rod 88 extended from the main body 87 in parallel with the input piston 58 in the cabin. The potentiometer 86 is mounted to a bracket 89 secured to the inner diameter boss 55a of the mounting member 55 for the housing 54 in parallel with the input piston 58.

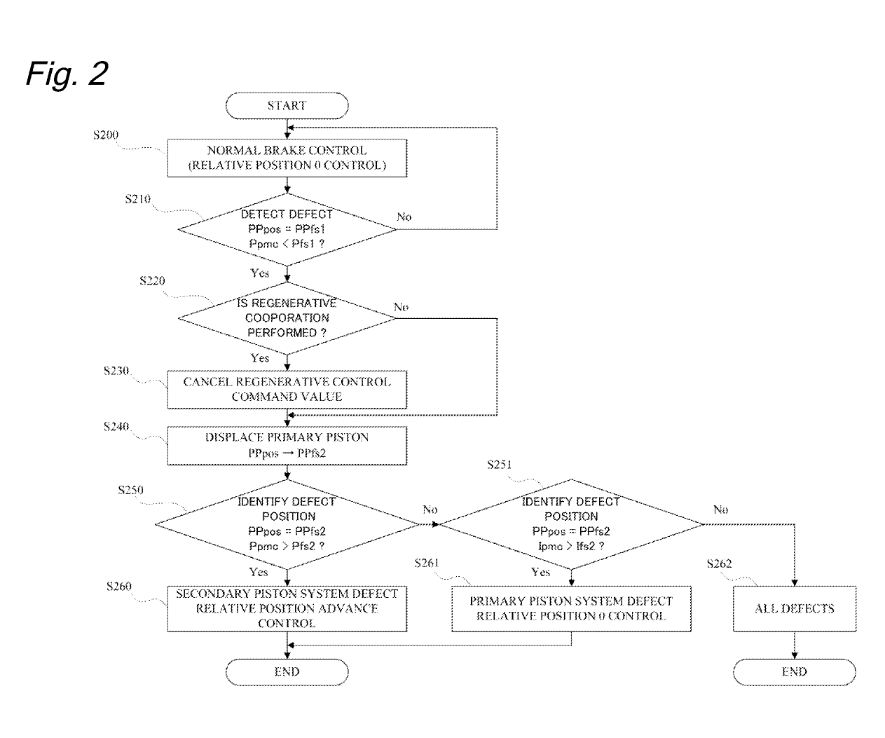

The sensor rod 88 is always urged in an extension direction by a spring included in the main body 87 so that a front end of the sensor rod 88 is brought into contact with a bracket 90 secured to the rear end of the input piston 58. Meanwhile, the electric motor 64 is herein constituted by an inverter-controlled DC brushless motor. The electric motor 64 includes a resolver 91 that detects a magnetic pole position for rotation control. The resolver 91 also has a function of detecting rotation displacement (rotation position) of the electric motor 64, and detecting absolute displacement of the primary piston 52 relative to the vehicle body based on the detection result. The potentiometer 86 and the resolver 91 have a displacement detection function of detecting a relative displacement amount between the input piston 58 and the primary piston 52. Each detection signal obtained by each member described above having the detection function is sent to the controller 92 that performs calculation and control shown in FIG. 2. In detection of the rotation displacement, not limited to the resolver, but a rotary potentiometer or the like that can detect absolute displacement (angle and rotation position) may be used.

In this embodiment, a hydraulic pressure sensor 114 is provided in the primary circuit 102, and detects hydraulic pressure in the primary side system. The brake system 1 of this embodiment is, for example, provided in a hybrid vehicle, and can cooperate with a regenerative brake in operating the electric motor 64 as a generator in deceleration and braking to control a braking force. The regenerative cooperative control can be performed to prevent deceleration feeling for the operation of the brake pedal from differing depending on the presence of the operation of the regenerative brake, and prevents a driver from feeling uncomfortable.

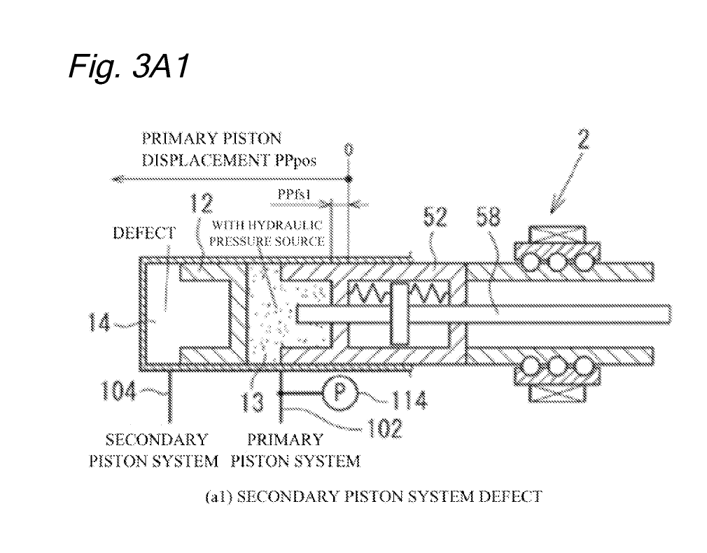

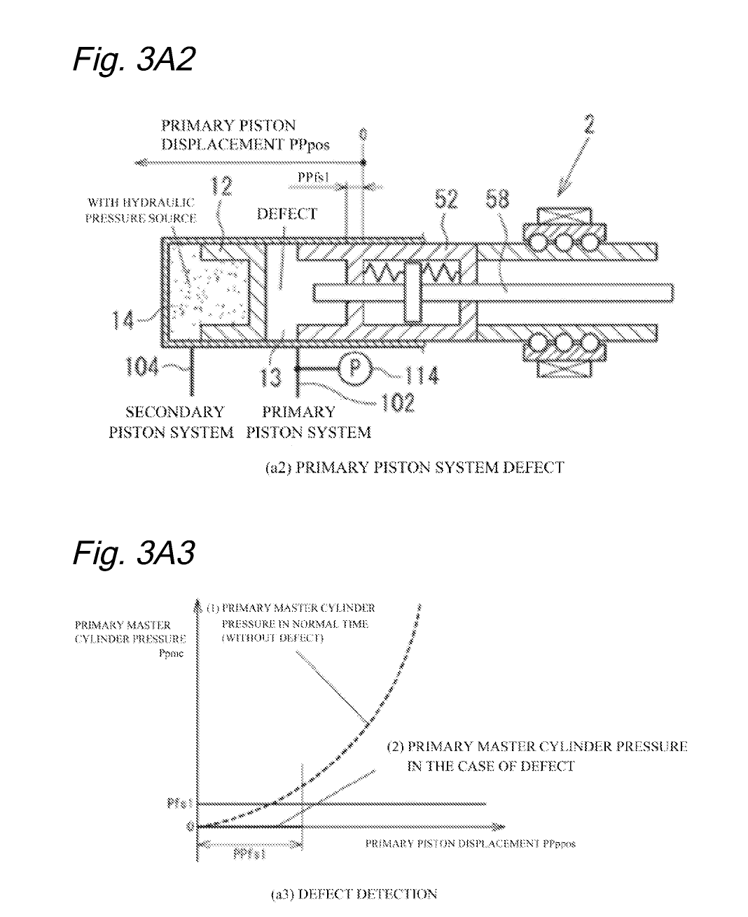

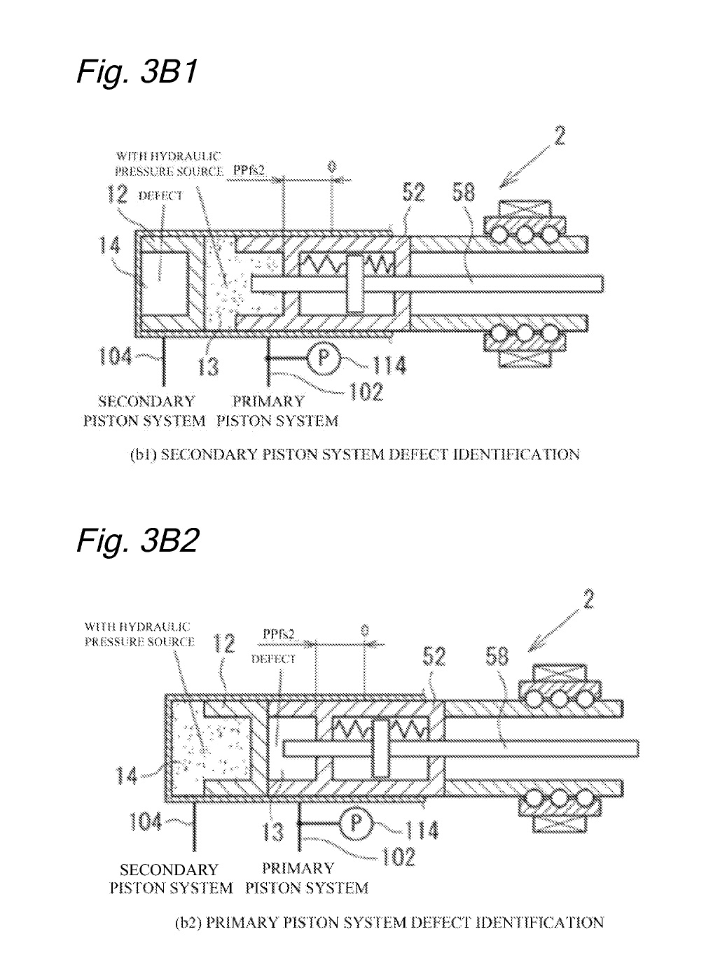

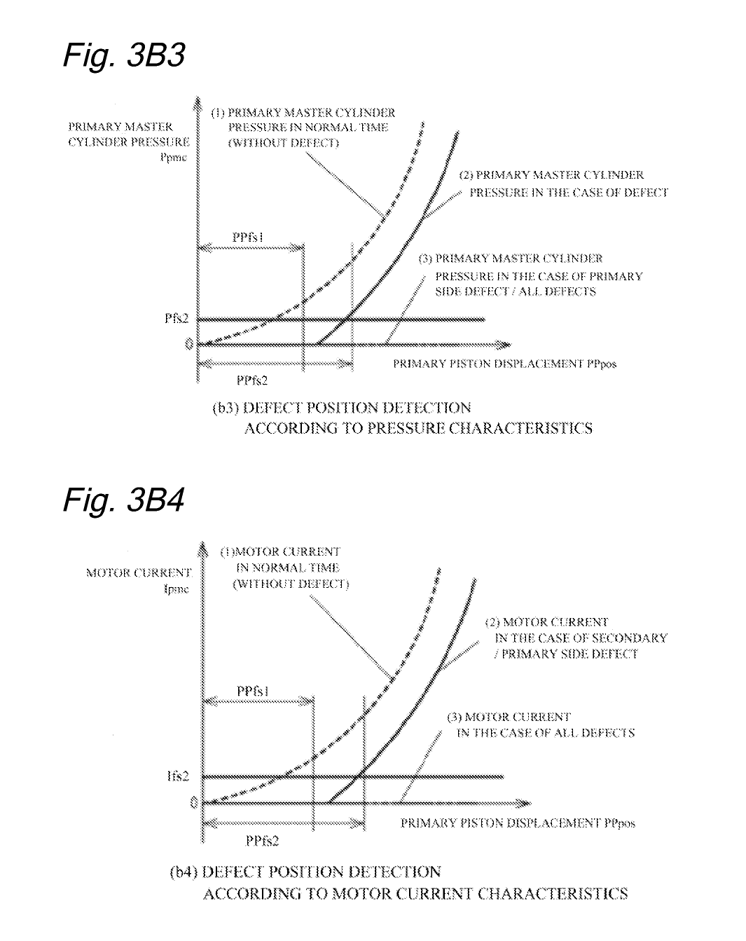

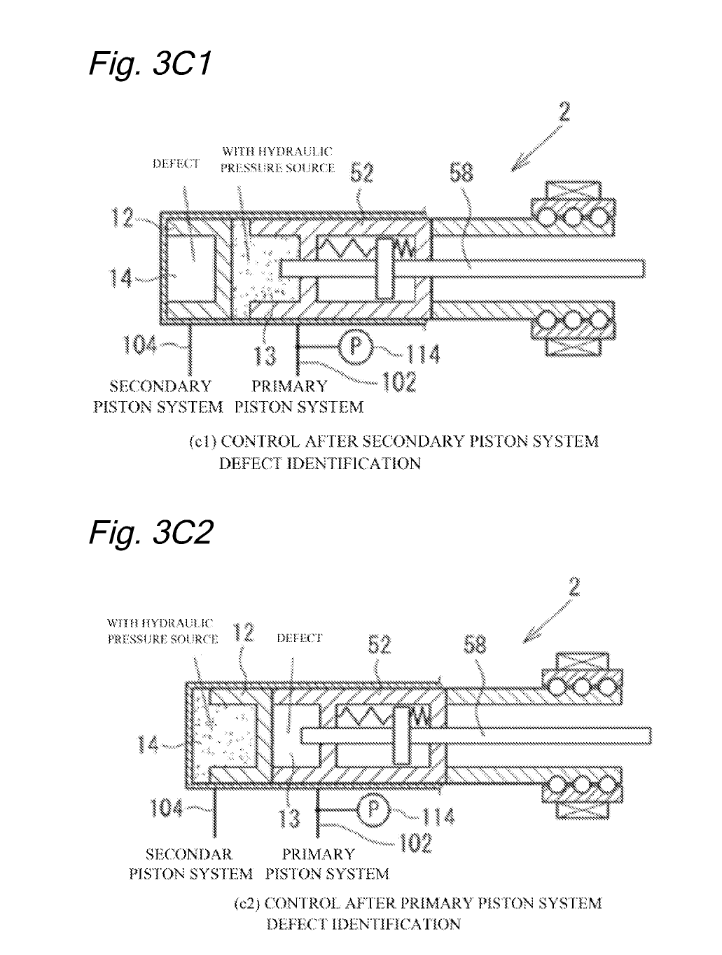

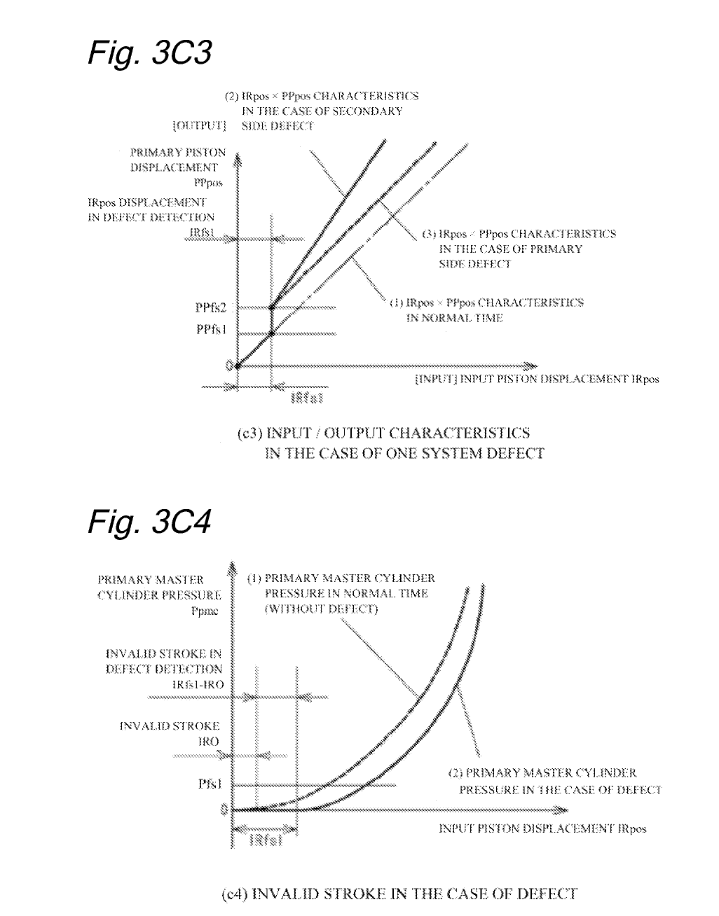

Operations of the brake system 1 according to this embodiment configured as described above will be now described together with the calculation and control processes performed by the controller 92 with reference to FIGS. 2, 3A1-3A3, 3B1-3B4 and 3C1-3C4.

In this embodiment, when a primary or secondary hydraulic pressure system is defective (each system being defective will be referred to as a primary side system defect or a secondary side system defect as appropriate. Corresponding to processes after Step S210 in FIG. 2), control (hereinafter referred to as a one system defect time control) is performed so that the primary piston 52 (assist member) is moved by a larger amount than an amount of movement of the input rod 9 (input member). This control is performed to compensate for a braking force for two nondefective wheels, which may be reduced by the defect. When there is no defect in the systems (hereinafter also referred to as normal time), normal brake control (also referred to as relative position 0 control as appropriate) is performed (Step S200 in FIG. 2).

First, the normal brake control (relative position 0 control) in normal time when no defect occurs in the hydraulic pressure systems will be described.

In this embodiment, when the brake pedal 8 is operated in normal time, the input piston 58 is advanced, and the movement of the input piston 58 is detected by the potentiometer 86. Then, the controller 92 receives a signal from the potentiometer 86 and outputs a drive command to the electric motor 64, and this rotates the electric motor 64. At this time, based on detection signals of the potentiometer 86 and the resolver 91, a relative displacement amount between the pistons is determined from a difference between absolute displacement of the input piston 58 and absolute displacement of the primary piston 52. Thus, the rotation of the electric motor 64 is controlled according to the signal from the potentiometer 86 so as not to cause the relative displacement between the input piston 58 and the primary piston 52. This control corresponds to the relative position 0 control. Then, the relative position 0 control is performed and thus the pair of springs 85 interposed between the pistons 58 and 52 maintain a neutral position, and the electric boosting device 50 at this time outputs hydraulic pressure (braking force) corresponding to an input at a certain boost ratio uniquely determined by an area ratio between pressure receiving areas of the primary piston 52 and the input piston 58.

Concurrently with the process of the normal brake control in Step S200, a defect detection process in Step S210 is performed for determining whether there is a defect in the systems. When it is determined that there is no defect in the systems (No), the process returns to Step S200, and the normal brake control (relative position 0 control) is continued, and when it is determined that there is a defect in the systems (Yes), the process proceeds to Step S220.

As shown in FIG. 3A3, the defect detection process in Step S210 compares whether pressure Ppmc in the primary-piston-side pressure chamber 13 is lower than a threshold Pfs1 preset for determining the presence of defect detection (Ppmc<Pfs1?) when displacement PPpos of the primary piston 52 reaches predetermined defect detection displacement PPfs1 (first position). When the result of the comparison shows that the pressure Ppmc is lower than the threshold Pfs1, it is determined that at least one of the hydraulic pressure systems is defective.

Situations relating to the comparison determination of the pressure Ppmc and the threshold Pfs1 will be described below.

Specifically, the controller 92 performs the defect detection process to monitor whether the hydraulic pressure circuit systems (primary and/or secondary side system) is defective. When performing the relative position 0 control, the controller 92 controls the electric motor 64 so that input/output of displacement IRpos of the input piston 58 obtained by an input from the potentiometer 86 and the displacement PPpos of the primary piston 52 obtained by an input from the resolver 91 have characteristics, for example, shown by the dash-single-dotted line (1) in FIG. 3C3. A stroke amount between initial displacement 0 of the input piston 58 and displacement of the input piston 58 at which actual application of a braking force is started (position where hydraulic pressure is generated in the pressure chambers 13 and 14) in response to a driver's pedal depression input, is referred to as an invalid stroke IRO of the input piston 58 as shown by the dotted line (1) in FIG. 3C4.

When the secondary side system is defective as shown in FIG. 3A1, the brake fluid in the secondary-piston-side pressure chamber 14 flows out of the hydraulic pressure circuit system even if the displacement of the primary piston 52 is increased with the displacement of the input piston 58 in accordance with the input/output characteristics indicated by dotted line (1) in FIG. 3C3, and thus pressure in the secondary-piston-side pressure chamber 14 is not generated (increased). Meanwhile, in the primary-piston-side pressure chamber 13, when the displacement of the primary piston 52 is advanced, the brake fluid trapped in the primary-piston-side pressure chamber 13 presses the secondary piston 12 forward, and the pressure in the primary-piston-side pressure chamber 13 is maintained at certain hydraulic pressure when the invalid stroke IRO is passed and is not increased, and the secondary piston 12 is displaced by a displacement amount of the primary piston 52.

As shown in FIG. 3A2, when the primary side system is defective, the brake fluid in the primary-piston-side pressure chamber 13 flows out of the hydraulic pressure circuit system even if the displacement of the primary piston 52 is increased with the displacement of the input piston 58, and thus pressure in the primary-piston-side pressure chamber 13 is not generated (increased). Also, since a force by the hydraulic pressure in the primary-piston-side pressure chamber 13 is not transmitted to the secondary piston 12, the secondary piston 12 is not moved forward, and the hydraulic pressure in the secondary-piston-side pressure chamber 14 is not generated (increased) until the primary piston 52 abuts against the secondary piston 12. Thus, when either the secondary or primary side system is defective, the pressure Ppmc in the primary-piston-side pressure chamber 13 is not increased as shown in FIG. 3A3 even if the displacement PPpos of the primary piston 52 is increased. Based on the above-described situations with respect to the defect and the hydraulic pressure or the like in the primary and secondary side systems, the comparison determination between the pressure Ppmc and the threshold Pfs1 is performed in the defect detection process to determine the presence of the defect detection as described above.

In Step S220, it is determined whether regenerative cooperative control is performed (whether regenerative cooperation is performed). When it is determined that the regenerative cooperation is not performed (No), the process proceeds to Step S240, and when it is determined that the regenerative cooperation is being performed (Yes), the process proceeds to Step S230.

In Step S230, to allow brake control in the case of a defect as described below to be performed, a regenerative cooperative control command based on a command from a master system is canceled. This is performed for the following reasons. Specifically, a regenerative cooperative control canceling process in Step S230 is performed when it is determined in Step S210 that there is a defect (Yes), and it is determined in successive Step S220 that the regenerative cooperation is performed (Yes). In this embodiment, the X pipe is used, and thus if regenerative cooperative braking control is performed when there is a defect, braking forces of the left and right wheels are out of balance. To avoid such a situation that the braking forces of the left and right wheels are out of balance, the regenerative cooperative control command is canceled as described above. Then, the regenerative cooperative control command is thus canceled to prevent the braking forces of the left and right wheels from being out of balance.

Following the regenerative cooperative control canceling process in Step S230, Step S240 is performed. In Step S240, to identify which of the primary side system and the secondary side system is defective, the controller 92 advances the displacement PPpos of the primary piston 52 to predetermined defect detection displacement PPfs2 irrespective of the displacement IRpos of the input piston 58 as shown in FIG. 3C3.

In Step S250 following Step S240, it is determined whether the pressure Ppmc in the primary-piston-side pressure chamber 13 when the displacement PPpos of the primary piston 52 is the defect detection displacement PPfs2 (second position) is higher than a threshold Pfs2 preset for identifying a defect detection position (Ppmc>Pfs2?).

When it is determined in Step S250 that the pressure Ppmc is higher than the threshold Pfs2 (Yes), the secondary side system is regarded to be defective, and the process proceeds to Step S260. When it is determined in Step S250 that the pressure Ppmc is the threshold Pfs2 or less (No), the process proceeds to Step S251. In Step S251, it is determined whether an electric motor current Ipmc when the displacement PPpos of the primary piston 52 is the defect detection displacement PPfs2 is higher than a threshold Ifs2 preset for identifying the defect detection position (Ipmc>Ifs2?). When it is determined in Step S251 that the electric motor current Ipmc is higher than the threshold Ifs2 (Yes), the primary side system is regarded to be defective, and the process proceeds to Step S261. When it is determined in Step S251 that the electric motor current Ipmc is the threshold Ifs2 or less (No), the primary side system and the secondary side system are regarded to be defective (all systems are defective), and the process proceeds to Step S262. Thus, the processes in Steps S250 and S251 are performed to identify the defect position.

The processes in Steps S240 and S250 are performed based on characteristics with respect to the defect and the hydraulic pressure in the primary and secondary side systems as described below. For advancing the displacement PPpos of the primary piston 52 to the predetermined defect detection displacement PPfs2 in Step S240, when the secondary side system is defective as shown in FIG. 3B1, the force by the hydraulic pressure in the primary-piston-side pressure chamber 13 presses and advances the secondary piston 12 to a position in abutment with an inner end of the master cylinder 2 irrespective of the amount of movement of the input piston 58. After the abutment, the displacement of the secondary piston 12 is constrained by the end of the master cylinder 2, and thus the hydraulic pressure corresponding to the displacement PPfs2 of the primary piston 52 is generated in the primary-piston-side pressure chamber 13 as shown by solid line (2) in FIG. 3B3.

As shown in FIG. 3B2, when the primary side system is defective or all systems are defective, the primary piston 52 is advanced to a position in abutment with an end of the secondary-piston-side pressure chamber 14 (the back of the secondary piston 12), and after the abutment, reaction by the hydraulic pressure in the secondary-piston-side pressure chamber 14 is through the end of the secondary piston 12 to the primary piston 52. At this time, the primary-piston-side pressure chamber 13 does not include a hydraulic pressure source, and thus the pressure Ppmc in the primary-piston-side pressure chamber 13 is 0 as shown by dotted line (3) in FIG. 3B3.

As such, the displacement PPpos of the primary piston 52 is advanced to the predetermined defect detection displacement PPfs2 in Step S240, and then it is determined in Step S250 whether the pressure Ppmc in the primary-piston-side pressure chamber 13 is higher than the threshold Pfs2, thereby allowing determination whether the secondary side system is defective.

The process in Step S240 is performed, and thus when the secondary side system is defective, the secondary piston 12 corresponding to the secondary side system is pressed and advanced to the position in abutment with the end of the master cylinder 2 irrespective of the amount of movement of the input piston 58, thereby allowing the hydraulic pressure to be quickly generated.

Next, the process in Step S251 is performed based on characteristics of the defect in the primary side system, the hydraulic pressure in the primary side system and the electric motor current Ipmc described below. Specifically, when only the primary side system is defective as shown by solid line (2) in FIG. 3B4, the reaction by the hydraulic pressure in the secondary-piston-side pressure chamber 14 is transmitted through the end of the secondary piston 12 to the primary piston 52. At this time, the controller 92 controls the rotation of the electric motor 64 against the reaction transmitted to the primary piston 52, and thus the electric motor current Ipmc corresponding to the reaction is generated (increased).

When all systems are defective, no load is applied to the electric motor 64, and thus the electric motor current Ipmc is 0 as shown by dotted line (3) in FIG. 3B4. From such characteristics, in Step S251, the electric motor current Ipmc when the displacement PPpos of the primary piston 52 is advanced to the defect detection displacement PPfs2 is compared with the threshold Ifs2 preset for identifying the defect detection position, thereby allowing determination whether the primary side system is defective or all systems are defective. In case that only the secondary side system is defective (FIG. 3B1), the rotation of the electric motor 64 is controlled against the reaction by the hydraulic pressure in the primary-piston-side pressure chamber 13, and thus the electric motor current Ipmc corresponding to the reaction is similarly generated as shown by the solid line (2) in FIG. 3B4.

In Step S260 after the secondary side system is regarded to be defective in Step S250, as shown in FIG. 3C1, the controller 92 controls the displacement PPpos of the primary piston 52 relative to the displacement IRpos of the input piston 58 according to input/output characteristics described later, with the displacement of the secondary piston 12 constrained by the end of the master cylinder 2, under the situation that only the secondary side system is defective.

In the case of a defect, as shown in FIG. 3C4, in addition to the invalid stroke IRO of the input piston 58 (the stroke amount between the initial displacement 0 of the input piston 58 and the displacement of the input piston 58 at which actual application of hydraulic pressure is started in response to the driver's pedal depression input), an invalid stroke IRfs1-IRO (a stroke amount between the displacement of the input piston 58 at which application of a boosting force is started in normal time and the displacement IRfs1 of the input piston 58 at which application of a boosting force is started when a defect is detected) is generated, which is generated before the defect detection in Step S210. To compensate for the invalid stroke of the input piston 58 and a reduction in braking force due to a defect at one of the systems, the input/output characteristics of the displacement IRpos of the input piston 58 and the displacement PPpos of the primary piston 52 are changed as shown by solid line (2) in FIG. 3C3 after identification of a one system defect in the secondary side system. Specifically, control is performed to advance the displacement PPpos of the primary piston 52 relative to the displacement IRpos of the input piston 58 by a larger amount than an amount of movement when both the systems are in normal state (hereinafter referred to as relative position advance control).

As an example of the relative position advance control (control to advance the displacement PPpos of the primary piston 52 relative to the displacement IRpos of the input piston 58 by a larger amount than an amount of movement when all systems are in normal state), in this embodiment, control is performed so that a ratio of the amount of movement of the primary piston 52 to the amount of movement of the input piston 58 is a predetermined value larger than 1 (fixed value such as 1.5, 2.0 or 2.3) for setting the amount of movement of the primary piston 52 relative to the amount of movement of the input piston 58 to be larger than that when both the systems are in normal state, when the secondary side system is defective.

In Step S261 after the primary side system is regarded to be defective in Step S251, as shown in FIG. 3C2, the controller 92 controls the displacement PPpos of the primary piston 52 relative to the displacement IRpos of the input piston 58 according to input/output characteristics described later, with the primary piston 52 abutting against the end of the secondary-piston-side pressure chamber 14, in the situation that when only the primary side system is defective.

Since the hydraulic pressure is not generated in the primary-piston-side pressure chamber 13 and the reaction is not applied to the input piston 58, the hydraulic pressure corresponding to wheel lock is easily generated in the secondary-piston-side pressure chamber 14 when the relative position advance control is performed as in Step S260. To avoid this, as shown by doted line (3) in FIG. 3C3, after identification of a one system defect of the primary side system, the relative position 0 control is performed in Step S261 as performed when all systems are in normal state. In this case, abutment control described below may be performed instead of the relative position 0 control. The abutment control is control of the displacement PPpos of the primary piston 52 in which a length of the input piston 58 is set so that a front end of the input piston 58 abuts against the end of the secondary piston 12 when the primary side system is defective, and hydraulic pressure reaction of the secondary-piston-side pressure chamber 14 is transmitted to the input piston 58. In this case, control may be performed so that the amount of movement of the primary piston 52 with respect to the amount of movement of the input piston 58 is smaller than that when all systems are in normal state.

In Step S262, drive control of the electric actuator 53 is stopped as a measure when all systems are defective.

In the first embodiment, as described above, when the secondary side system is defective, the primary piston 52 (assist member) is moved by a larger amount than an amount of movement of the input piston 58 (input member), and the pressure in the nondefective primary side system is increased. This can compensate for a braking force for two wheels of the primary system, which may be reduced by the defect if no measure is taken, and allows a desired braking force to be generated in a nondefective system. Further, the pressure in the primary side system is increased to apply the hydraulic pressure reaction to the input piston 58 and the input rod 9 (input member), thereby achieving good pedal feeling.

According to the first embodiment, as described above, when the secondary side system is defective, a desired braking force can be generated in at least nondefective system. This can avoid an insufficient braking force of the nondefective system, which may be caused in the case of a defect according to the conventional technique, and allows a desired braking force to be generated in the nondefective system.

In the first embodiment, the defect detection and the position identification are performed by providing the hydraulic pressure sensor 114 in only the primary circuit 102, and this can reduce installment space, mounting time, and costs as compared with the case where hydraulic pressure sensors 114 are provided in a plurality of positions.

In the first embodiment, the pressure in the primary-piston-side pressure chamber 13 at the specific displacement of the primary piston 52 is compared with the threshold for the defect detection so as to perform the defect detection. However, not limited to this, determination may be performed by calculating a pressure difference between the target pressure in the primary-piston-side pressure chamber 13 calculated by the controller 92 for the displacement PPpos of the primary piston 52 and the pressure in the primary-piston-side pressure chamber 13 measured by the hydraulic pressure sensor 114, and comparing the pressure difference with a preset threshold.

In the first embodiment, for moving the primary piston 52 by a larger amount than an amount of movement of the input piston 58 when the secondary side system is defective, the control is performed so that the ratio of the amount of movement of the primary piston 52 (an amount of advance of the displacement PPpos of the primary piston 52) to the amount of movement of the input piston 58 (displacement IRpos of the input piston 58) is a predetermined value larger than 1 (fixed value such as 1.5, 2.0 or 2.5). Instead, the predetermined value may be a variable value increasing or decreasing at a predetermined rate with the movement of the input piston 58, within a range larger than 1 rather than the fixed value, or a value curvedly varying with the movement of the input piston 58 within a range larger than 1.

For the system including the hydraulic pressure sensors 114 provided in both the hydraulic pressure circuit systems (primary side system) of the primary-piston-side pressure chamber 13 and the hydraulic pressure circuit system (secondary side system) of the secondary-piston-side pressure chamber 14, a defect detection method of the primary and secondary side systems may be as described below. In this system, the controller 92 calculates a pressure difference between the target pressure of the primary side system (pressure chamber 13) calculated based on the displacement of the primary piston 52 and the pressure in each of the primary side system (pressure chamber 13) and the secondary side system (pressure chamber 14) each measured by the corresponding hydraulic pressure sensor 114, and compares the pressure difference with the preset threshold, and thus determines that the system that does not reach the threshold is defective so as to detect a defect at one of the systems. The pressure in the primary side system (pressure chamber 13) and the secondary side system (pressure chamber 14) measured by each hydraulic pressure sensor 114 may be used to compare the pressure in the primary side system (pressure chamber 13) and the secondary side system (pressure chamber 14) in the specific displacement of the primary piston 52 with the threshold for the defect detection so as to perform the defect detection as described in the defect detection process in Step S210.

In the embodiment, the controller 92 may be configured to control the electric actuator 53 so that a piston of the defective system is stopped in a position where a front end of the piston abuts against a cylinder or another piston upon a release of the operation of the brake pedal 8 when either the primary or secondary side system is defective. Such a configuration allows hydraulic pressure to be quickly generated.

In the above-mentioned embodiment, an occurrence of a defect in the secondary side system is determined based on the pressure Ppmc in the step S250, and after that, an occurrence of a defect in the primary side system and an occurrence of defects in all systems is determined based on the electric current Ipmc in the step S251. However, the order of these steps may be reversed, because the system having a defect can be determined from the combination of values of the pressure Ppmc and the electric current Ipmc when the displacement PPpos of the primary piston 52 is the defect detection displacement PPfs2, and reversing the order of the defect determination steps does not make any difference.

That is, when a defect occurs in the primary side system (the system equipped with the pressure sensor), the pressure Ppmc is smaller than Pfs2 (Ppmc<Pfs2), and the electric current Ipmc is larger than Ifs2 (Ipmc>Ifs2).

When a defect occurs in the secondary side system (the system without the pressure sensor), the pressure Ppmc is larger than Pfs2 (Ppmc>Pfs2), and the electric current Ipmc is larger than Ifs2 (Ipmc>Ifs2).

When all systems are defective, the pressure Ppmc is smaller than Pfs2 (Ppmc<Pfs2), and the electric current Ipmc is smaller than Ifs2 (Ipmc<Ifs2).

Therefore, it is possible to detect which system has a defect by determining the values of the pressure and the electric current, regardless of the order of the defect determination steps.

More specifically, when the step S251 is carried out first, if the result is NO in the step S251, then it is determined that all systems are defective (S262). If the result is YES in the step S251, then the step 250 is carried out. If the result is No in the step S250, it is determined that the primary side system is defective, and then the step S261 is carried out. If the result is YES in the step S250, it is determined that the secondary side system is defective, and then the step S260 is carried out.

Further, in the above-mentioned embodiment, the hydraulic sensor 114 is disposed at the primary side system, although it may be disposed at the secondary side system. In this case, it is determined whether or not the pressure Psmc of the secondary-piston-side pressure chamber 14 when the displacement PPpos of the primary piston 52 is the defect detection displacement PPfs2 is larger than the threshold value Pfs2 which is preset for determination of a defect detection position (Psmc>Pfs2?). If it is determined that the pressure Psmc is larger than the threshold value Pfs2 (YES), then it can be determined that the primary side system is defective.

Further, in the above-mentioned embodiment, in the step S210, the pressure Ppmc of the primary-piston-side pressure chamber 13 is compared to the threshold value Pfs1 which is preset for determination whether a defect is detected or not (Ppmc<Pfs1?), when the displacement PPpos of the primary piston 52 reaches the predetermined defect detection displacement PPfs1. However, the step S210 may be carried out by comparing the electric current Ipmc of the electric motor to the threshold value Ifs1 of the electric current, which is preset for determination whether a defect is detected or not. In this case, as a result of this comparison, it can be determined that a defect occurs in the hydraulic system if the electric current Ipmc is smaller than the threshold value Ifs1.

### Second Embodiment

In the first embodiment, when a defect is detected upon a pedal depression, the pedal is then once released and then second pedal depression and thereafter is detected, defect detection performed for each time may cause the invalid stroke IRfs1-IRO in the defect detection shown in FIG. 3C4 is generated each time. In this connection, to prevent the invalid stroke IRfs1-IRO in the defect detection from being generated every time the second pedal depression and thereafter is detected, there is a measure example (hereinafter referred to as a second embodiment) such that a controller 92 stores a result of a previous defect detection process.

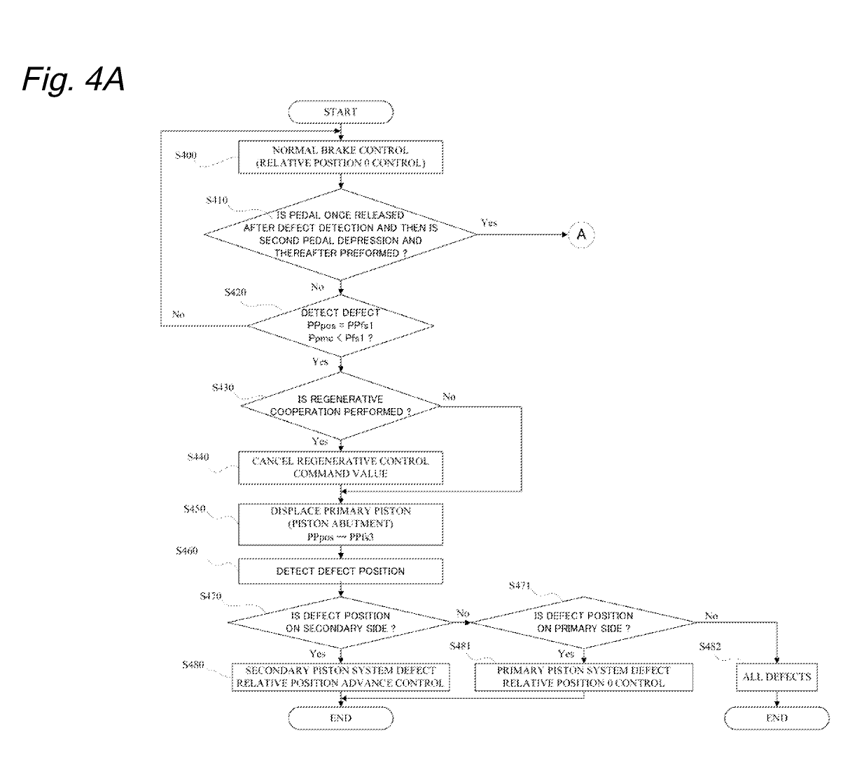

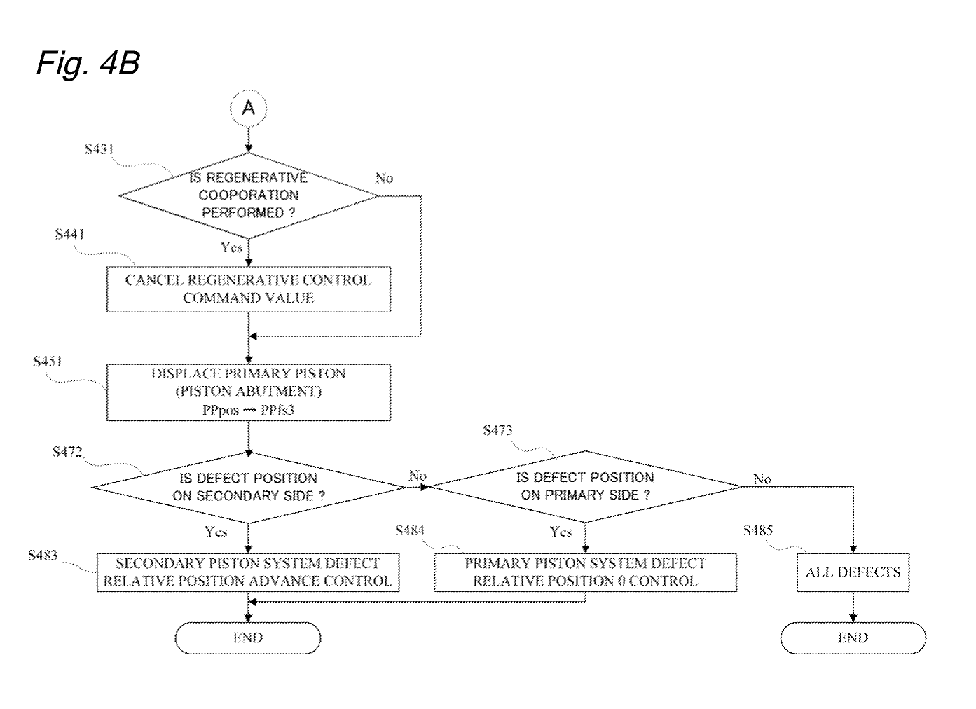

In the second embodiment, for the measure example, calculation and a control process shown in FIGS. 4A and 4B performed by a controller 92 (hereinafter referred to as a second embodiment controller 92B for convenience) are different from calculation and a control process (FIG. 2) performed by the controller 92 in the first embodiment. The second embodiment will be described below based on FIGS. 4A and 4B with reference to FIGS. 1A, 1B, 2, 3A1-3A3, 3C1-3C4 and FIGS. 5-1 to 5-4.

In FIGS. 4A and 4B, steps performed by the second embodiment controller 92B include steps having processes corresponding to those of the steps (FIG. 2) performed by the controller 92 in the first embodiment, although different reference numerals are denoted. The steps having the same processes are correspondingly listed below.

Step S400-Step S200, Step S420-Step S210,

Step S430-Step S220, Step S431-Step S220,

Step S440-Step S230, Step S441-Step S230,

Step S480-Step S260, Step S481-Step S261,

Step S482-Step S262, Step S483-Step S260,

Step S484-Step S261, Step S485-Step S262

The second embodiment controller 92B includes Step S420 in a control program thereof as shown in FIG. 4A and always monitors whether a hydraulic pressure circuit system is defective in Step S420.

Further, the second embodiment controller 92B determines in Step S410 following Step S400 (see Step S200 in FIG. 2) in FIG. 4A whether “a defect is detected, the pedal is then once released and then second pedal depression and thereafter is performed” (a defect is detected in a previous defect detection process, and second driver's pedal depression and thereafter is performed).

When it is determined in Step S410 that a defect is detected in the previous defect detection process, and the second driver's pedal depression and thereafter is performed (Yes), the process proceeds to Step S431 in FIG. 4B to skip the defect detection process in Step S420.

When it is determined in Step S410 that a defect is not detected in the previous defect detection process (No), the process proceeds to Step S420 to always monitor a defect.

For “the detection of a defect in the previous defect detection process” used for determination in Step S410, a result of a storing process performed with defect position detection in Step S460 described later is used. In this embodiment, the result of the previous defect detection process is stored and used to perform the determination process in Step S410 and to perform a skip process for the defect detection process in Step S420 performed when it is determined Yes in Step S410 (hereinafter simply referred to as a skip process) for the following reasons.

Specifically, when a defect is detected upon the pedal depression, the pedal is then once released and then second pedal depression and thereafter is detected, a defect detection performed for each time may cause an invalid stroke IRfs1-IRO in the defect detection as shown in FIG. 3C4 to generate each time. To avoid such a situation, the determination process in Step S410 and the skip process are performed.

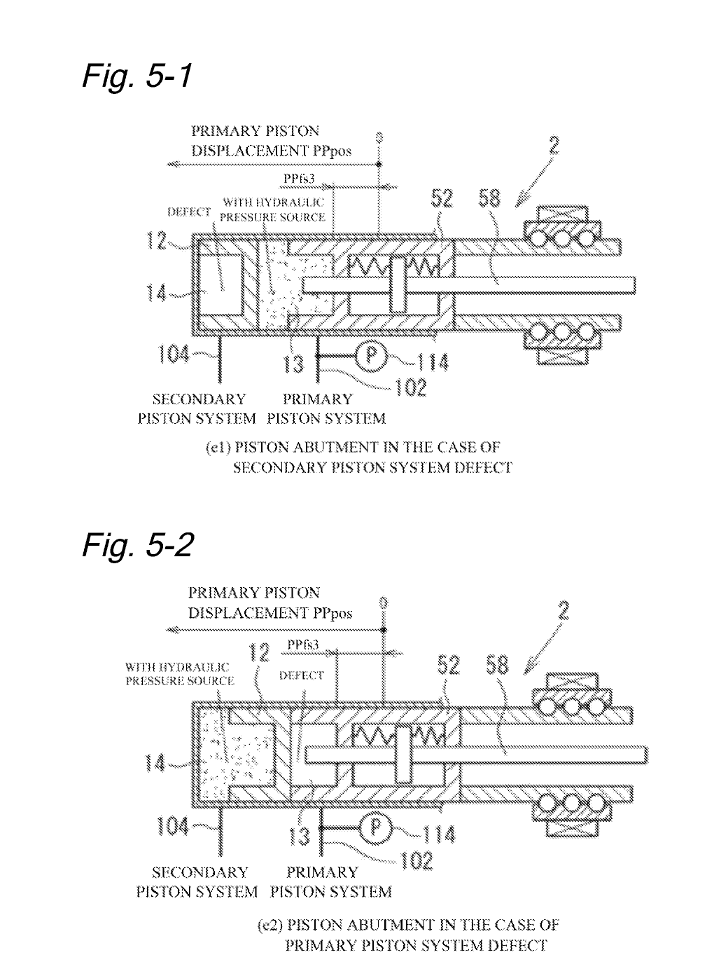

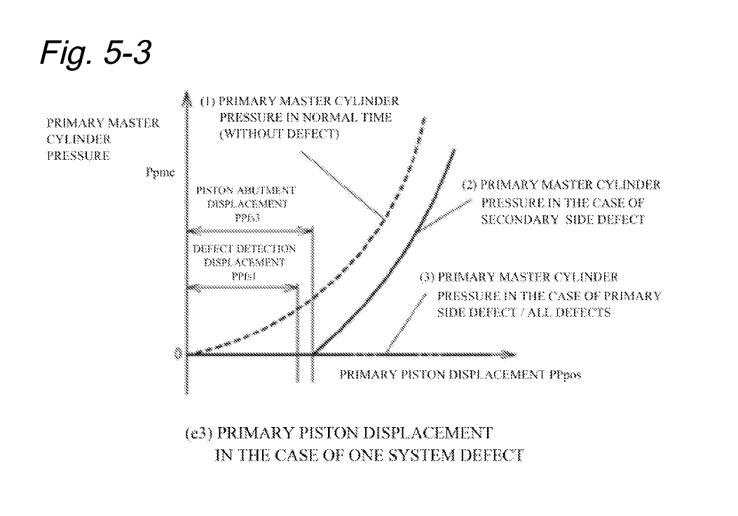

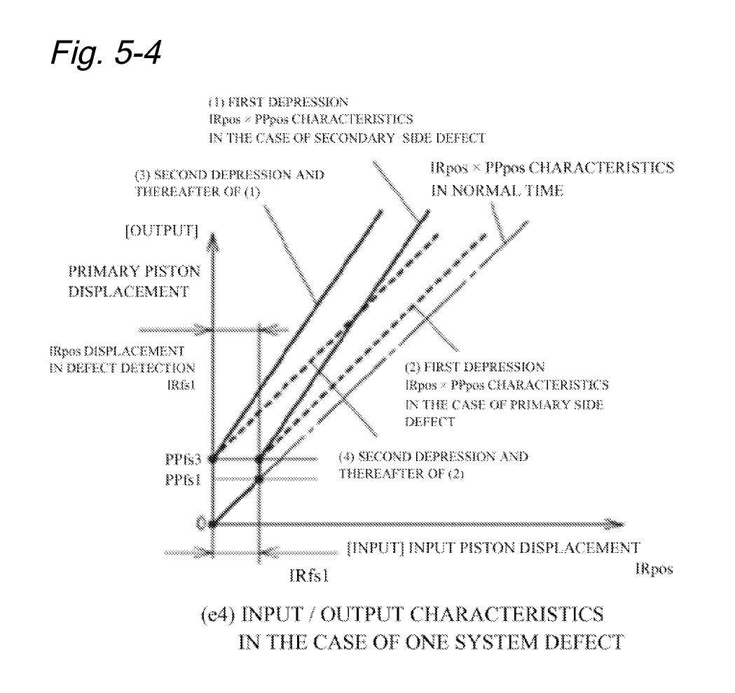

In Step S450, when defect detection is performed, the primary piston 52 is advanced from a defect detection displacement PPfs1 to a piston abutment displacement PPfs3 irrespective of displacement of the input piston 58 as shown by solid line (1) and dotted line (2) in FIG. 5-4. This process is performed because when either the primary or secondary side system is defective and if the relative position 0 control is continued, a braking force by a desired boost force ratio cannot be obtained before the displacement PPpos of the primary piston 52 reaches the piston abutment displacement PPfs3 as shown in FIG. 5-3 for the reasons described below.

The piston abutment displacement PPfs3 of the primary piston 52 is displacement PPpos of the primary piston 52 required for moving a piston of the defective system to a position where a front end of the piston abuts against a cylinder or another piston as shown in FIGS. 5-1 and 5-2.

As shown in FIG. 3A1, when the secondary side system is defective, reaction is not generated from the secondary-piston-side pressure chamber 14 even if the displacement of the primary piston 52 is increased with the displacement of the input piston 58. Thus, the pressure in the primary-piston-side pressure chamber 13 is maintained without being increased, and only the reaction by the hydraulic pressure in the primary-piston-side pressure chamber 13 causes displacement of the secondary piston 12 by an amount of displacement of the primary piston 52. Hydraulic pressure is not generated in the secondary-piston-side pressure chamber 14, thus the pressure in the secondary-piston-side pressure chamber 14 is not increased, and a braking force by a desired boost force ratio cannot be obtained.

Similarly, when the primary side system is defective as shown in FIG. 3A2, hydraulic pressure is not generated in the primary-piston-side pressure chamber 13 even if the displacement of the primary piston 52 is increased with the displacement of the input piston 58, and thus the pressure in the primary-piston-side pressure chamber 13 is not increased. A force by hydraulic pressure in the primary-piston-side pressure chamber 13 is not transmitted to the secondary piston 12, the hydraulic pressure in the secondary-piston-side pressure chamber 14 is not generated, and thus a braking force by desired hydraulic pressure cannot be obtained.

In Step S451, as shown by solid line (3) and dotted line (4) in FIG. 5-4, the primary piston 52 is advanced from an initial position 0 to the piston abutment displacement PPfs3 irrespective of the displacement of the input piston 58.

This process is performed because when second depression of driver's pedal operation is detected after the defect detection, a braking force by the desired hydraulic pressure cannot be obtained before the displacement PPpos of the primary piston 52 reaches the piston abutment displacement PPfs3 as shown in FIG. 5-3.

In Step S460, the second embodiment controller 92B switches control according to a defect position of the secondary side system/primary side system, and thus the defect position is detected by unshown defect position detection means, and the defect position detected by the defect position detection means is stored. The detected defect position is stored because the stored defect position is used to prevent the invalid stroke IRfs1-IRO in the defect detection from being generated every time the second pedal depression and thereafter is detected (see Step S410).

As the defect position detection means, either detection means (a) or (b) is used.

(a) Detection means for detecting which of the secondary side system and the primary side system is defective based on the characteristics of the pressure Ppmc in the primary-piston-side pressure chamber 13 and the electric motor current Ipmc with regard to the displacement of the primary piston 52 (see Steps S240, S250 and S251 in Embodiment 1), or detection means for detecting which of the secondary side system and the primary side system is defective based on the characteristics of the pressure Psmc in the secondary-piston-side pressure chamber 14 and the electric motor current Ipmc with regard to the displacement of the primary piston 52.

(b) Detection means in which a hydraulic pressure sensor 114 is provided in each of the hydraulic pressure circuit system of the primary-piston-side pressure chamber 13 and the hydraulic pressure circuit system of the secondary-piston-side pressure chamber 14, the second embodiment controller 92B calculates a pressure difference between the target pressure in the primary-piston-side pressure chamber 13 calculated based on the displacement of the primary piston 52, and the pressure in the primary-piston-side pressure chamber 13 and the secondary-piston-side pressure chamber 14 each measured by the corresponding hydraulic pressure sensor 114, the pressure difference is compared with a preset threshold, and thus it is determined that the pressure chamber system that does not reach the threshold is defective so as to detect a one system defect.

In Step S470, it is determined whether the defect position is the secondary-piston-side pressure chamber 14. When it is determined Yes (that the defect position is the secondary-piston-side pressure chamber 14) in Step S470, the process proceeds to Step S480. When it is determined No (that the defect position is not the secondary-piston-side pressure chamber 14) in Step S470, the process proceeds to Step S471. In Step S471, it is determined whether the defect position is the primary-piston-side pressure chamber 13. When it is determined Yes (that the defect position is the primary-piston-side pressure chamber 13) in Step S471, the process proceeds to Step S481. When it is determined No (that the defect position is not the primary-piston-side pressure chamber 13) in Step S471, the process proceeds to Step S482.

In Step S472, it is determined whether the defect position is the secondary-piston-side pressure chamber 14. When it is determined Yes (that the defect position is the secondary-piston-side pressure chamber 14) in Step S472, the process proceeds to Step S483. When it is determined No (that the defect position is not the secondary-piston-side pressure chamber 14) in Step S472, the process proceeds to Step S473. In Step S473, it is determined whether the defect position is the primary-piston-side pressure chamber 13. When it is determined Yes (the defect position is the primary-piston-side pressure chamber 13) in Step S473, the process proceeds to Step S484. When it is determined No (that the defect position is not the primary-piston-side pressure chamber 13) in Step S473, the process proceeds to Step S485.

According to the second embodiment, when a defect is detected upon the pedal depression, the pedal is then once released and then second pedal depression and thereafter is detected, it is determined Yes in Step S410 and the defect detection process in the Step S420 is skipped. This can avoid a situation where the invalid stroke IRfs1-IRO in the defect detection is generated every time the second pedal depression and thereafter is detected.

### Third Embodiment

In the first embodiment, if the displacement of the primary piston 52 is returned to the initial displacement 0 according to the displacement IRpos of the input piston 82 when the driver releases the pedal after the defect detection, even after the one system defect detection, a braking force by desired hydraulic pressure cannot be obtained before the displacement PPpos of the primary piston 52 reaches the piston abutment displacement PPfs3 every time the pedal depression is detected. In this connection, to always start the displacement of the primary piston 52 from the piston abutment displacement PPfs3 when the pedal depression is detected after the defect detection, there is a measure example such that a controller stores results of previous defect detection/defect position detection processes (hereinafter referred to as a third embodiment).

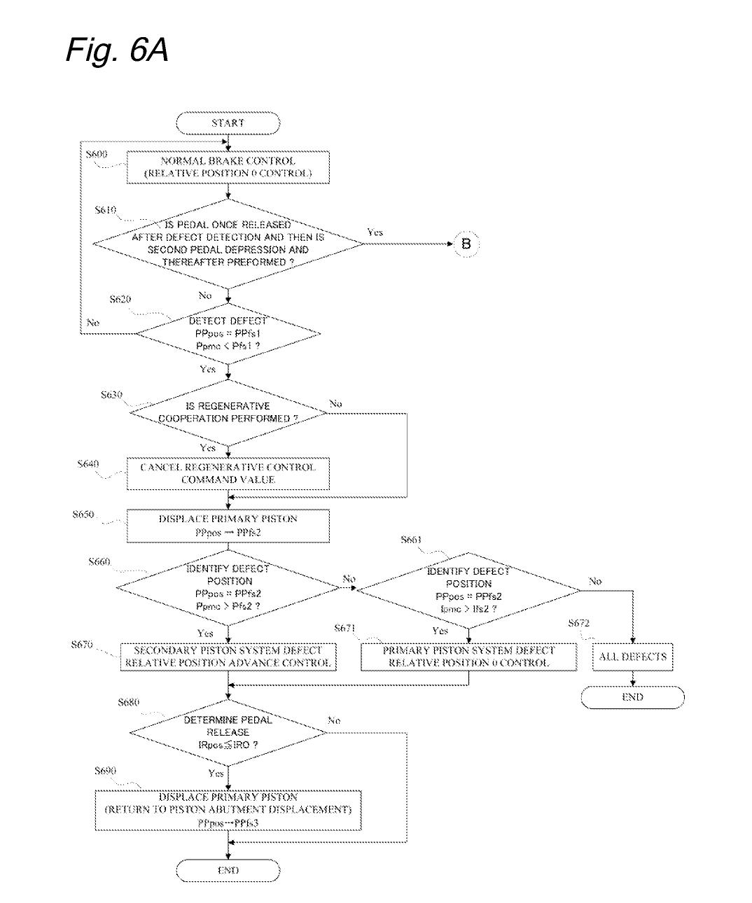

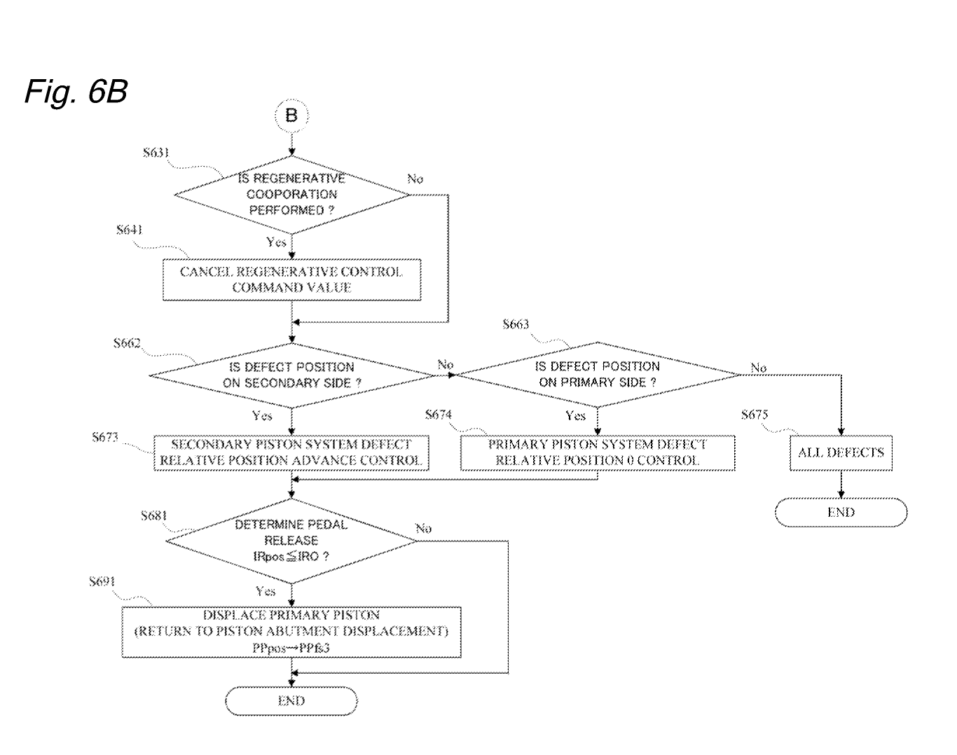

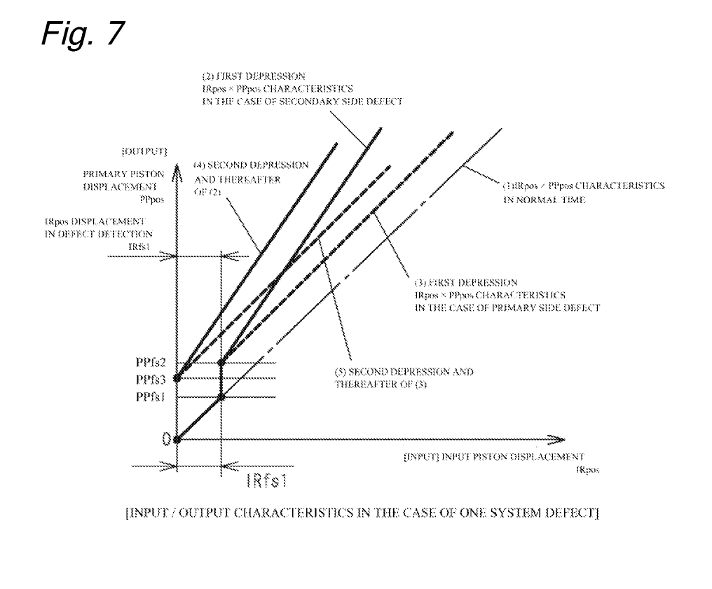

The third embodiment is different mainly in that calculation and a control process shown in FIGS. 6A and 6B performed by a controller 92 (hereinafter referred to as a third embodiment controller 92C for convenience) are different from calculation and a control process (FIG. 2) performed by the controller 92 in the first embodiment. The third embodiment will be described below based on FIGS. 6A, 6B and 7 with reference to FIGS. 1A, 1B and 2.

In FIGS. 6A and 6B, steps performed by the third embodiment controller 92C include steps having processes corresponding to those of the steps (FIG. 2) performed by the controller 92 in the first embodiment, although different reference numerals are denoted. The steps having the same processes are correspondingly listed below.

Step S600-Step S200, Step S620-Step S210,

Step S630-Step S220, Step S631-Step S220,

Step S640-Step S230, Step S641-Step S230,

Step S650-Step S240, Step S660-Step S250,

Step S661-Step S251, Step S670-Step S260,

Step S671-Step S261, Step S672-Step S262,

Step S673-Step S260, Step S674-Step S261,

Step S675-Step S262

The third embodiment controller 92C includes Step S620 in a control program thereof as shown in FIG. 6A, and always monitors whether a hydraulic pressure circuit system is defective in Step S620. Further, the third embodiment controller 92C determines in Step 610 following Step S600 in FIG. 6A (see Step S200 in FIG. 2) whether “a defect is detected, the pedal is then once released and then second pedal depression and thereafter is performed” (a defect is detected in a previous defect detection process, and second driver's pedal depression and thereafter is performed).

When it is determined Yes (that a defect is detected in the previous defect detection process and the second driver's pedal depression and thereafter is performed) in Step S610, the process proceeds to Step S631 in FIG. 6B to skip the defect detection process in Step S620.

When it is determined No (No determination is performed in the case where “a defect is detected in the previous defect detection process and the second driver's pedal depression and thereafter is not performed” and also the case where “a defect is not detected in the previous defect detection process”) in Step S610, the process proceeds to Step S620 to always monitor a defect. For “the detection of a defect in the previous defect detection process” used for determination in Step S610, a result of a storing process (a result of the defect detection/defect position detection process) performed before a displacement process of the primary piston 52 in Steps S690 and S691 described later is used.

In this embodiment, the result of the previous defect detection/defect position detection process is stored and used to perform the determination process in Step S610 and a skip process for the defect detection process in Step S620 performed when it is determined Yes in Step S610 (hereinafter simply referred to as a third embodiment skip process) for the following reasons. Specifically, if the displacement of the primary piston 52 is returned to the initial displacement 0 according to the displacement IRpos of the input piston 82 when the driver releases the pedal after the defect detection, even after the one system defect detection, a braking force by a desired boost force ratio cannot be obtained before the displacement PPpos of the primary piston 52 reaches the piston abutment displacement PPfs3 every time the pedal depression is detected. To avoid such a situation, the determination process in Step S610 and the third embodiment skip process are performed.

In Step S662, it is determined whether the defect position is the secondary-piston-side pressure chamber 14. When it is determined Yes (that the defect position is the secondary-piston-side pressure chamber 14) in Step S662, the process proceeds to Step S673. When it is determined No (that the defect position is not the secondary-piston-side pressure chamber 14) in Step S662, the process proceeds to Step S663.

In Step S663, it is determined whether the defect position is the primary-piston-side pressure chamber 13. When it is determined Yes (that the defect position is the primary-piston-side pressure chamber 13) in Step S663, the process proceeds to Step S674. When it is determined No (that the defect position is not the primary-piston-side pressure chamber 13) in Step S663, the process proceeds to Step S675 (process when all systems are defective).

In Step S680, as shown in FIG. 7, to always start the displacement of the primary piston 52 from the piston abutment displacement PPfs3 in the second depression after the defect detection, it is determined whether the displacement IRpos of the input piston 58 is the invalid stroke IRO or less of the input piston 58 (IRpos≦IRO?), thus pedal release determination is performed.

When it is determined Yes (IRpos≦IRO) in Step S680, the process proceeds to Step S690 to return the displacement PPpos of the primary piston 52 to the piston abutment displacement PPfs3. When it is determined No (IRpos>IRO) in Step S680, the control in FIGS. 6A and 6B is finished (the process proceeds to “END”).

In Step S681, as shown in FIG. 7, to always start the displacement of the primary piston 52 from the piston abutment displacement PPfs3 in the second depression after the defect detection, it is determined whether the displacement IRpos of the input piston 58 is the invalid stroke IRO or less (IRpos≦IRO?), thus pedal release determination is performed.

When it is determined Yes (IRpos≦IRO) in Step S681, the process proceeds to Step S691 to return the displacement PPpos of the primary piston 52 to the piston abutment displacement PPfs3. When it is determined No (IRpos>IRO) in Step S681, the control in FIGS. 6A and 6B is finished (the process proceeds to “END”).

In Step S690, the displacement of the primary piston 52 is returned to the piston abutment displacement PPfs3.

In Step S691, the displacement of the primary piston 52 is returned to the piston abutment displacement PPfs3.

According to the third embodiment, when a defect is detected in the previous defect detection process and the second driver's pedal depression and thereafter is performed, it is determined Yes in Step S610 and the defect detection process in Step S620 is skipped. This allows a desired braking force to be obtained in the nondefective system even when the second pedal depression and thereafter is performed after one system defect detection.

According to the embodiments described above, a desired braking force can be generated in a nondefective system even when at least the secondary side system is defective.

Although only some exemplary embodiments of this invention have been described in detail above, those skilled in the art will readily appreciate that many modifications are possible in the exemplary embodiments without materially departing from the novel teaching and advantages of this invention. Accordingly, all such modifications are intended to be included within the scope of this invention.

The entire disclosure of Japanese Patent Application No. 2009-111083 filed on Apr. 30, 2009 including specification, claims, drawings and summary is incorporated herein by reference in its entirety.

What is claimed is:

1. A brake system comprising:
a master cylinder that includes two pistons slidably provided in a cylinder, and in which brake hydraulic pressure is generated in two chambers of primary and secondary pressure chambers and is supplied from the primary and secondary pressure chambers to a wheel cylinder via a primary side system and a secondary side system respectively;
an electric boosting device that includes an input member that is moved forward and backward by an operation of a brake pedal and to which hydraulic pressure in the primary pressure chamber is applied, and an assist member that is moved forward and backward by an electric actuator, the electric boosting device generating brake hydraulic pressure in the master cylinder from an input thrust applied from the brake pedal to the input member and an assist thrust applied from the electric actuator to the assist member; and
a control device that drives the electric actuator in response to an operation of the input member,
wherein, when the secondary side system of the primary and secondary side systems is defective, the control device drives the electric actuator so that an amount of movement of the assist member relative to an amount of movement of the input member is larger than that when both the systems are in a normal state.

2. The brake system according to claim 1, wherein the control device drives the electric actuator so that a piston of the defective system is moved to a position where a front end of the piston abuts against the cylinder or another piston irrespective of an amount of movement of the input member, when it is detected that either the primary or secondary side system is defective.

3. The brake system according to claim 2, wherein the control device drives the electric actuator so that the piston of the defective system is moved to the position where the front end of the piston abuts against the cylinder or another piston irrespective of an amount of movement of the input member without performing defect detection processing for each operation of the brake pedal after a defect in the systems is detected.

4. The brake system according to claim 2, wherein a hydraulic pressure sensor that detects hydraulic pressure is provided in only the primary side system, and the control device determines a defect in the secondary side system based on a detection value of the hydraulic pressure sensor when the piston of the defective system is moved to the position where the front end of the piston abuts against the cylinder or another piston.

5. The brake system according to claim 3, wherein a hydraulic pressure sensor that detects hydraulic pressure is provided in only the primary side system, and the control device determines a defect in the secondary side system based on a detection value of the hydraulic pressure sensor when the piston of the defective system is moved to the position where the front end of the piston abuts against the cylinder or another piston.

6. The brake system according to claim 1, wherein a hydraulic pressure sensor that detects hydraulic pressure is provided in only one of the primary side system and the secondary side system, and
if a pressure detected by the hydraulic pressure sensor is less than a predetermined pressure or an electric current supplied to the electric actuator is less than a predetermined current, when the assist member is moved to a first position, the control device drives the electric actuator to move the assist member to a second position in a pressuring direction, and
the control device determines a defect in the primary and secondary side systems, based on the pressure detected by the hydraulic pressure sensor and the electric current supplied to the electric actuator, when the assist member is at the second position.

7. The brake system according to claim 1, wherein the control device controls the electric actuator so that the piston of the defective system is stopped at the position where the front end of the piston abuts against the cylinder or another piston upon a release of the operation of the brake pedal, when one of the primary and secondary side systems is defective.
